(19) United States
(12) Patent Application Publication
(10) Pub. No.: US 2024/0329005 A1
(43) Pub. Date: Oct. 3, 2024

(54) MULTI PUMP-PROBE ENCODING-DECODING FOR OPTO-ACOUSTIC METROLOGY

(71) Applicant: Onto Innovation Inc., Wilmington, MA (US)

(72) Inventors: Michael J. Kotelyanskii, Chatham, NJ (US); Manjusha Mehendale, Morristown, NJ (US); George Andrew Antonelli, Flanders, NJ (US); Robin A. Mair, West Chicago, IL (US)

(73) Assignee: Onto Innovation Inc., Wilmington, MA (US)

(21) Appl. No.: 18/612,243

(22) Filed: Mar. 21, 2024

Related U.S. Application Data
(60) Provisional application No. 63/493,545, filed on Mar. 31, 2023.

(51) Int. Cl. G01N 29/24; G01N 29/04; G01N 29/34

(52) U.S. Cl. CPC G01N 29/2418; G01N 29/041; G01N 29/343; G01N 2291/0231; G01N 2291/055; G01N 2291/057

(57) ABSTRACT

An opto-acoustic metrology device is configured to measure or inspect structures in a sample using both vertical and lateral transient perturbations. Multiple probe beams that have different locations of incidence may detect both the vertical and lateral transient perturbations produced by a pump beam, or a single probe beam may detect both the vertical and lateral transient perturbations produced by multiple pump beams that have different locations of incidence. The multiple probe beams or multiple pump beams are modulated with orthogonal waveforms, which allow the measurement of the different locations without interference from one another. The received signals are demodulated based on the orthogonal waveforms to recover the contributions to the received signals associated with each of the multiple probe beams or each of the multiple pump beams.

### CROSS REFERENCE TO RELATED APPLICATIONS

This application claims priority under 35 U.S.C. § 119 to U.S. Provisional Application No. 63/493,545, filed Mar. 31, 2023, entitled “MULTI PUMP-PROBE ENCODING-DECODING FOR OPTO-ACOUSTIC METROLOGY,” which is assigned to the assignee hereof and is incorporated herein by reference in its entirety.

### FIELD OF THE DISCLOSURE

The subject matter described herein is related generally to microscopy, and more particularly to the use of an opto-acoustic measurements.

### BACKGROUND

Optical metrology is used to provide non-contact evaluation of a sample and is often used in semiconductor and other similar industries during processing. For example, the manufacturing processes used in semiconductor and similar industries relies on sequential processing steps to build up layers to produce the desired device, e.g., electronic circuit. These processing steps include the deposition and patterning of material layers, such as insulating layers, polysilicon layers, and metal layers in semiconductor devices. The material layers are typically patterned using a photoresist layer that is patterned over the material layer using a photomask or reticle. Typically, the photomask has alignment targets or keys that are aligned to fiduciary marks formed in the previous layer on the substrate. The alignment of a lithographically defined pattern on top of the underlying pattern, sometimes referred to as overlay, is fundamental to device operation in all multi-layer patterned process flows. Misalignment between layers or patterns may lead to device failure and, accordingly, is one characteristic that is desirable to evaluate during processing. Another device characteristic that is fundamental to device operation is critical dimension (CD), e.g., line or feature width, line spaces, line height, and sidewall angle. Characterizing CD is important to ensure that the device meets the design target.

There are various optical metrology techniques that may be used conventionally for characterizing overlay and/or CD or other desired device characteristics. For example, conventional imagining techniques may use specific wavelengths of light, e.g., ultraviolet (UV), visible, or infrared (IR), to image the structures in the sample, e.g., including underlying structures with which the overlying layer is to be aligned. However, in the fabrication of some structures, optically opaque layers may be present and may overlay structures to be measured. Optically opaque materials, such as found in semi-damascene process flow or after the processing of the magnetic tunnel junction (MTJ) of a magnetic random-access memory (MRAM) may be present between target structures, which presents particular challenges for measuring underlying structures as well as alignment and overlay control. The presence of intervening opaque materials, for example, typically requires extra patterning operations thereby adding significant process cost. Microscopy techniques that can measure opaque and buried structures are therefore desirable.

### SUMMARY

An opto-acoustic metrology device is configured to measure or inspect structures of a sample using multiple probe beams or multiple pump beams, which are incident at different locations on the sample. The opto-acoustic metrology device detects both vertical and lateral transient perturbations in the sample. The opto-acoustic metrology device, for example, may use multiple probe beams with different locations of incidence to detect both the vertical and lateral transient perturbations produced by a pump beam, or may use a probe beam to detect both the vertical and lateral transient perturbations produced by multiple pump beams that have different locations of incidence. The multiple probe beams or the multiple pump beams are encoded and decoded, e.g., using orthogonal waveforms, so that the individual contributions to the received signals by the multiple probe beams or multiple pump beams may be recovered.

In one implementation, a method of opto-acoustic metrology of a sample includes directing a pump beam that includes pump pulses towards a surface of the sample. The pump beam generates vertical transient perturbation in the sample and a lateral transient perturbation in the sample. The method further includes generating a plurality of probe beams, with each probe beam including probe pulses, and modulating each probe beam in the plurality of probe beams. The plurality of probe beams is directed towards different locations on the surface of the sample and the plurality of probe beams is reflected from the surface of the sample. A first reflected probe beam is modified based on the vertical transient perturbation propagating perpendicular to the surface of the sample and at least one second reflected probe beam is modified based on the lateral transient perturbation propagating along the surface of the sample. The method further includes demodulating the first reflected probe beam and the at least one second reflected probe beam. The method further includes determining at least one characteristic of the sample based on the vertical transient perturbation obtained from demodulating the first reflected probe beam and based on the lateral transient perturbation obtained from demodulating the at least one second reflected probe beam.

In one implementation, a metrology device for opto-acoustic metrology of a sample includes a pump arm that is configured to receive at least a first portion of pulsed light from a light source and to direct a pump beam comprising pump pulses towards a surface of the sample. The pump beam generates vertical transient perturbation in the sample and a lateral transient perturbation in the sample. The metrology device further includes a probe arm that is configured to receive at least a second portion of the pulsed light from the light source and to direct a plurality of probe beams towards different locations on the surface of the sample, each probe beam includes probe pulses. The probe arm includes a means for modulating each probe beam in the plurality of probe beams. The plurality of probe beams is reflected from the surface of the sample, and a first reflected probe beam is modified based on the vertical transient perturbation propagating perpendicular to the surface of the sample and at least one second reflected probe beam is modified based on the lateral transient perturbation in the sample propagating along the surface of the sample. The metrology device further includes a means for demodulating the first reflected probe beam and the at least one second reflected probe beam. The metrology device further includes a means for determining at least one characteristic of the sample based on the vertical transient perturbation obtained from demodulating the first reflected probe beam and based on the lateral transient perturbation obtained from demodulating the at least one second reflected probe beam.

In one implementation, a method of opto-acoustic metrology of a sample includes generating a plurality of pump beams, each pump beam including pump pulses, and modulating each pump beam in the plurality of pump beams. The method includes directing the plurality of pump beams towards different locations on a surface of the sample, and each pump beam excites transient perturbations in the sample at corresponding locations. The method further includes directing a probe beam including probe pulses towards the surface of the sample, the probe beam is reflected from the surface of the sample. A reflected probe beam is modified based on vertical transient perturbations in the sample propagating perpendicular to the surface of the sample and lateral transient perturbations propagating along the surface of the sample that are excited by the plurality of pump beams. The method further includes demodulating the reflected probe beam, and determining at least one characteristic of the sample based on the vertical transient perturbations and the lateral transient perturbations obtained from demodulating the reflected probe beam.

In one implementation, a metrology device for opto-acoustic metrology of a sample includes a pump arm that is configured to receive at least a first portion of pulsed light from a light source and to direct a plurality of pump beams towards different locations on a surface of the sample, each pump beam including pump pulses. The pump arm includes a means for modulating each pump beam in the plurality of pump beams. Each pump beam excites transient perturbations in the sample at corresponding locations. The metrology device further includes a probe arm that is configured to receive at least a second portion of the pulsed light from the light source and to direct a probe beam including probe pulses towards the surface of the sample and the probe beam is reflected from the surface of the sample. A reflected probe beam is modified based on vertical transient perturbations in the sample propagating perpendicular to the surface of the sample and lateral transient perturbations propagating along the surface of the sample that are excited by the plurality of pump beams. The metrology device further includes a means for demodulating the reflected probe beam, and a means for determining at least one characteristic of the sample based on the vertical transient perturbations and the lateral transient perturbations obtained from demodulating the reflected probe beam.

### BRIEF DESCRIPTION OF THE DRAWINGS

FIG. 1 illustrates a block diagram of an opto-acoustic metrology device that uses multiple pump beams or multiple probe beams that are modulated, e.g., with orthogonal waveforms.

FIGS. 2A and 2B illustrate a side cross-sectional view and a top view, respectively, of a sample being measured or inspected by an opto-acoustic metrology device using a single pump beam and multiple probe beams with orthogonal waveform modulation.

FIG. 2C is a graph illustrating the change in reflectivity (ΔR) over time (t) of a demodulated signal produced by reflected probe beams illustrated in FIGS. 2A and 2B.

FIGS. 3A and 3B illustrate a side cross-sectional view and a top view, respectively, of a sample being measured or inspected by an opto-acoustic metrology device using multiple pump beams with orthogonal waveform modulation and a single probe beam.

FIG. 3C is a graph illustrating the change in reflectivity (ΔR) over time (t) of a demodulated signal produced by reflected probe beam illustrated in FIGS. 3A and 3B.

FIGS. 4A and 4B illustrate examples of orthogonal waveforms that may be used to modulate multiple probe beams or multiple pump beams.

FIGS. 5A and 5B illustrate schematic representations of example opto-acoustic metrology devices that use a single pump beam and multiple probe beams that are modulated with orthogonal waveforms.

FIG. 6 illustrates a schematic representation of an example opto-acoustic metrology device that uses multiple pump beams that are modulated with orthogonal waveforms and a single probe beam.

FIG. 7 is a flow chart illustrating a process of opto-acoustic metrology of a sample using multiple probe beams.

FIG. 8 is a flow chart illustrating a process of opto-acoustic metrology of a sample using multiple pump beams.

### DETAILED DESCRIPTION

Opto-acoustic measurements, such as picosecond laser acoustic (PLA) measurements, may be used for the measurement of structures on devices, such as semiconductor devices and other similar types of devices. Opto-acoustic metrology techniques, for example, enable measurement of opaque devices or devices below opaque layers, e.g., for analysis of CD or overlay. The use of opto-acoustic techniques is advantageous as it does not rely on the penetration of opaque layers or structures by light, but instead generates and detects acoustic waves that propagate through optically opaque layers and structures. Opto-acoustic techniques may also be used to measure non-opaque structures and unburied structures, i.e., top layer structures.

Opto-acoustic techniques characterize samples by recording and analyzing the response of the sample to the action of a pump beam and the corresponding effect on a reflected probe beam. The pump beam, for example, irradiates a target sample that causes a transient perturbation in the target material. The probe beam likewise irradiates the target sample, and the reflected probe beam is altered based on the transient perturbation in the target material. In a conventional pump-probe measurement technique used in opto-acoustic measurements, the pump beam and/or the probe beam is typically frequency modulated with a sinusoidal waveform, and the measured signal from the reflected probe beam is demodulated in order to improve the signal to noise ratio (SNR).

Conventional opto-acoustic techniques, however, have limitations. For example, opto-acoustic metrology devices are typically configured to measure only bulk propagating elastic waves, e.g., transient perturbations in the vertical direction, or surface propagating elastic waves, e.g., transient perturbations in the horizontal direction, depending on the location of the probe beam relative to the pump beam. The single pump-single probe beam configuration of conventional opto-acoustic metrology devices limit throughput due to the one-to-one arrangement of pump and probe beams.

It may be advantageous, however, to have a one-to-many (or many-to-one) (or many-to-many) arrangement of pump and probe beams. For example, the response to a single pump action may be collected with a plurality of probe beams, strategically located to measure both the bulk and surface propagating elastic waves and their interactions with the structure of interest. Likewise, a similar measurement may be performed by collecting the response of a single probe beam to a plurality of pump beams acting in sequence or simultaneously at locations selected to measure both the bulk and surface propagating elastic waves and their interactions with the structure of interest. Moreover, a similar measurement may be performed by collecting the response of a plurality of probe beams to a plurality of pump beams acting in sequence or simultaneously at locations selected to measure both the bulk and surface propagating elastic waves and their interactions with the structure of interest. The use of a one-to-many (or many-to-one) (or many-to-many) arrangement of pump and probe beams may provide additional useful information related to both the bulk and surface properties, as well as improve throughput. Triangulation or trilateration, for example, may be used for determining location or overlay of the features.

As discussed herein, a system for opto-acoustic metrology and/or inspection uses multiple pump beams and/or multiple probe beams, e.g., multiple pump beams and a single probe beam, a single pump beam and multiple probe beams, or multiple pump beams and multiple probe beams. A pump beam and probe beam may illuminate the same location on the sample surface, while the remaining beams illuminate different locations. The signals from the one or more probe beams may be collected with a single detector. An encoding/decoding scheme is used to separate the contributions of the multiple beams to the collected signal. For example, the encoding/decoding scheme may modulate the pump and/or probe beams, for example, with orthogonal waveforms, such as but not limited to sine-cosine pairs at different frequencies, wavelets such as Haar Wavelets or Daubechies wavelets, or other orthogonal waveforms. The modulation used may be optimized for a given application and/or geometry of the test structure, as well as repeat rates, duty cycles, pulse train synchronization of the pump and probe beams.

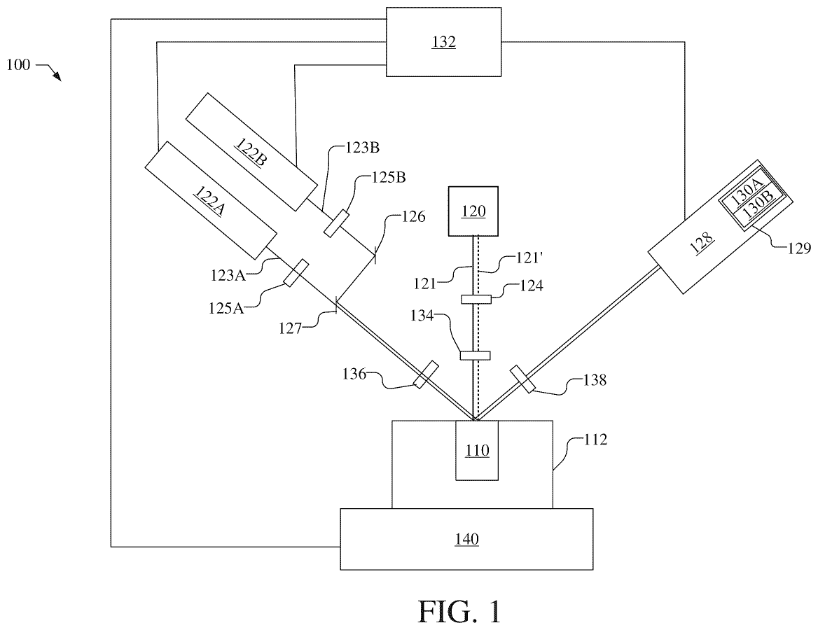

FIG. 1 illustrates a block diagram of an example opto-acoustic metrology device 100 that may use multiple pump beams, multiple probe beams, or both multiple pump and multiple probe beams, and includes an encoding/decoding scheme in which the pump and/or probe beams are modulated, for example, with orthogonal waveforms, as discussed herein.

The opto-acoustic metrology device 100 is illustrated with a pump beam source 120 and probe beam sources 122A and 122B. The pump beam source 120 may include, for example, a laser, and may be referred to herein as an excitation laser. The probe beam sources 122A and 122B, sometimes collectively referred to as probe beam sources 122, may include at least one laser, and may be referred to herein as a detection lasers. In some implementations, the probe beam sources 122A and 122B may use the same laser and may include a beam splitter to split the emitted light into separate probe beams. Additionally, in some implementations, the pump beam source 120 and the probe beam sources 122 may use the same laser and may include a beam splitter to split the emitted light into separate pump and probe beams. The pump beam source 120 and the probe beam sources 122 may additionally include delay stages (not shown) for increasing or decreasing the length of the optical path between the laser and the sample 112.

In the illustration of FIG. 1, the pump beam source 120 may produce a single pump beam 121, while multiple probe beams are produced by probe beam sources 122, illustrated as probe beams 123A and 123B, sometimes referred to as probe beams 123. A probe beam 123A may be incident on the sample 112 at the same location as the pump beam 121, while probe beam 123B is incident on the sample 112 at a slightly different location. In some implementations, the pump beam source 120 may produce multiple pump beams, illustrated as pump beam 121 and pump beam 121′ (shown with dotted lines), and only a single probe beam source 122A may be used to produce a probe beam 123A that is incident at the same location as the pump beam 121 and the pump beam 121′ may be incident on the sample 112 at a slightly different location. In some implementations, the pump beam source 120 may produce multiple pump beams, illustrated as pump beam 121 and pump beam 121′, and multiple probe beam sources 122A, 122B may be used to produce probe beams 123A and 123B. In such an implementation, some, but not necessarily all, the pump beams 121, 121′ are incident on the sample 112 at different locations, the probe beams 123A and 123B are incident on the sample 112 at different locations, and some, but not necessarily all of the pump beams and probe beams may be paired to be incident on the sample 112 at the same locations.

It should be understood that while FIG. 1 illustrates multiple probe beams as including two probe beams 123A and 123B, the multiple probe beams may include a greater number of probe beams if desired. Further, while FIG. 1 illustrates multiple pump beams as including two pump beams 121 and 121′, the multiple pump beams may include a greater number of pump beams if desired.

The opto-acoustic metrology device 100 further includes a number of modulators, e.g., pump beam modulator 124 and probe beam modulators 125A and 125B. In an implementation with multiple pump beams 121 and 121′, a separate pump beam modulator may be used for each pump beam. In some implementations, the modulators may be an electro-optic modulator (EOM), photo-elastic modulator (PEM), acousto-optic modulator (AOM), a mechanical chopper, etc. The modulators, e.g., probe beam modulators 125A and 125B, are used to encode the probe beams 123A and 123B, e.g., with orthogonal waveforms, so that the contributions from each probe beam modulator to a detected signal may be separated. The probe beam modulators 125A and 125B, for example, may modulate the probe beams 123A and 123B with single frequencies sine and cosine pairs, at different frequencies. In other implementations, the probe beam modulators 125A and 125B may modulate the probe beams 123A and 123B with orthogonal wavelets, such as, but not limited to Haar wavelets or Daubechies wavelets. Other types of orthogonal waveforms may be used, such as multiplexed signals, e.g., an orthogonal frequency-division multiplexing signal, or orthogonal chirp signals. In some implementations, the pump beam modulator 124 may additionally modulate the pump beam 121, e.g., pump intensity modulation. If multiple pump beams 121 and 121′ are used, e.g., in place of multiple probe beams 123A and 123B, the pump beams 121 and 121′ may be frequency modulated by separate pump beam modulators.

The opto-acoustic metrology device 100 may include various additional optical elements to direct the pump and probe beams to be incident on the sample 112 and to receive reflected probe beams and detect a resulting signal. For example, as illustrated in FIG. 1, the opto-acoustic metrology device 100 may include a mirror 126 and beam splitter 127, as well as lenses 134, 136 and 138, and a detector 128. The lenses 134 and 136 may be configured to adjust the spot sizes of the pump beam 121 and probe beams 123 based upon the particular target to be measured, and to control the location of incidence of the pump beam 121 and probe beams 123. The spot sizes of the respective beams may be similar or dissimilar. Additional optical elements, such as filters, polarizers, etc., may be used, but are not shown in FIG. 1.

The detector 128 receives the probe beams 123A and 123B after being reflected from the sample 112. In some implementations, the pump beam 121 may be incident on the sample 112 along the same optical path as the probe beams, and the opto-acoustic metrology device 100 may include a beam dump (not shown) for capturing light from the pump beam returned from the sample 112. The detector 128, for example, may be a photodetector or PIN photodiode. The reflectivity of the reflected light, for example, at the top surface of the structure 110 is altered due to changes in reflectivity or surface deformation due to the bulk and surface waves. The detector 128 may be configured to receive and demodulate the reflected probe pulses to sense a change in the intensity of the probe beams caused by the changes in reflectivity and/or interference oscillations. The detector 128 may include, or may be coupled to, a lock-in amplifier 129 that includes multiple demodulators 130A and 130B to phase lock on the received signal. The demodulators 130A and 130B, for example, correspond to the probe beam modulators 125A and 125B, and are used to decode the contributions from each probe beam to the received signal based on the orthogonal waveforms of the probe beams 123A and 123B produced by probe beam modulators 125A and 125B. The demodulators 130A and 130B, for example, may be physical band-pass filters, digital processing, or a combination thereof. In an implementation in which multiple pump beams and a single probe beam are used, the demodulators 130A and 130B correspond to the multiple pump beam modulators, and are used to decode the contributions from each pump beam to the received signal based on the orthogonal waveforms of the pump beams 121 and 121′ produced by pump beam modulators. If both the pump pulses and probe pulses are frequency modulated, a combination, e.g., a sum or difference, of the frequencies in the received probe beams may be demodulated.

The pump pulses and probe pulses may be produced with different delays, and the detector 128 may generate signals in response to received reflected probe beams 123 with a different time delay between the pump pulses and probe pulses. Each signal, for example, is in response to bulk waves and surface waves. The bulk waves corresponding to an arrival of acoustic echoes after reflection from underlying layers at different depths within the patterned structure with which structures and the underlying layers of the patterned structure may be detected. The surface waves corresponding with the arrival of surface waves propagating through various structural elements and materials near the surface of the sample with which structures and materials in the patterned structure may be detected. The detector 128 may record a change in reflectivity or surface deformation of the sample 112 due to the bulk and surface waves at the location of incidence of each probe beam 123 and/or pump beam 121 as a function of a time delay between the pump pulses and the probe pulses.

The opto-acoustic metrology device 100 further includes a mechatronic support 140 for the sample 112 of which structure 110 is a part. The mechatronic support 140 being adapted to move the sample 112 relative to the pump and probe beams to obtain measurements from desired positions on the sample 112. The device further includes a processing system 132 coupled to the pump beam source 120 and probe beam sources 122 the mechatronic support 140, and the detector 128. It should be appreciated that the processing system 132 may be a self-contained or distributed computing device capable of performing computations, receiving, and sending instructions or commands and of receiving, storing, and sending information related to the metrology functions of the device.

In the depicted implementation, the pump beam 121 and probe beams 123 do not share an optical path to and from the sample 112. For example, as illustrated, pump beam 121 is at normal (or near normal) incidence and probe beams 123 are at oblique incidence. In some implementations, however, the pump beam 121 may be at oblique incidence and the probe beams 123 may be at normal (or near normal) incidence. In some implementations, the pump beam 121 and probe beams 123 may share an optical path to the sample 112. Thus, a number of different configurations may be used with the optical paths being the same, partially overlapping, adjacent, or coaxial. In some implementations, the pump and probe beams may be derived from the same light source, e.g., a pulsed laser. The pump beam source 120 and probe beam source 122 may be controlled directly so as to obtain the temporal spacing between the pulses of light directed to the sample 112.

In operation, the processing system 132 directs a series of pulses of light from the pump beam source 120 to the structure 110. These pulses of light are incident upon and at least partially absorbed by at least one layer in the structure 110. The absorption of the light causes a transient expansion in the material of the structure 110 that causes bulk and surface waves at the same time depending on the pump beam characteristics. The expansion is short enough that it induces what is essentially an ultrasonic wave that propagates vertically (i.e., perpendicular to the surface of the structure 110) and is reflected at each underlying interface in the film stack and returned to the top surface, which is referred to as a bulk ultrasonic wave. The expansion further induces an ultrasonic wave that propagates horizontally along the surface of the structure 110 and is attenuated or otherwise affected by structures and various materials in the structure 110, which is referred to as a surface ultrasonic wave or transversal (shear) ultrasonic wave.

In addition to directing the operation of the pump beam source 120, the processing system 132 directs the operation of the probe beam sources 122. Probe beam sources 122 direct light in a series of light pulses that is incident on the structure 110, which reflect from the top layer of the structure 110 and are affected by the bulk or surface ultrasonic waves produced in the structure 110 by the pump beam 121. For example, the probe beam 123A that is incident at or near the location of incidence of the pump beam 121 is affected by the bulk ultrasonic waves traveling vertically in the structure 110, while the other probe beam 123B that is incident at a different location than the pump beam 121 is affected by the surface ultrasonic waves traveling horizontally in the structure 110. If multiple pump beams 121 and 121′ and a single probe beam 123A are used, the probe beam 123A is incident at or near the location of incidence of the pump beam 121 but at a different location than the other pump beam 121′ and the probe beam 123A is affected by the bulk ultrasonic waves traveling vertically in the structure 110 due to pump beam 121 and is affected by the surface ultrasonic waves traveling horizontally in the structure 110 due to pump beam 121′.

It should be appreciated that many optical configurations are possible. In some configurations the pump beam 121 may be produced with a pulsed laser with a pulse width in the range of several hundred femtoseconds to a few picoseconds and the probe beams 123A and 123B may be coupled to beam deflection systems. For example, delay stages (not shown) may be included in the probe beam sources 122A and 122B (and the pump beam source 120) for increasing or decreasing the length of the optical path to the structure 110. The delay stage may be controlled by processing system 132 to obtain the time delays in the light pulses that are incident on the object. Many other alternative configurations are also possible. It should be appreciated that the schematic illustration of FIG. 1 is not intended to be limiting, but rather depict one of a number of example configurations for the purpose of explaining the new features of the present disclosure.

The processing system 132 is configured to collect and analyze the data obtained from the sample 112 by the detector 128 using lock-in amplifier 129 and multiple demodulators 130A and 130B. The processing system 132 may determine at least one characteristic of the sample 112 using the vertical transient perturbations and the lateral transient perturbations obtained from demodulating the reflected probe beams 123A and 123B (or using only reflected probe beam 123A if multiple pump beams 121 and 121′ are used). The processing system 132, for example, may determine locations and compositions of underlying structures in the sample 112 based on the vertical transient perturbations and may determine locations and compositions of structures in the surface of the sample 112 based on the lateral transient perturbations. The processing system 132 may, for example, detect structures and composition of materials at different depths or locations in the surface of the sample 112 by varying the known delay between the pump pulses and the probe pulses. Additionally, with the use of three or more probe beams (or pump beams) and the known arrangement of the locations of incidence of the pump and probe beams, the processing system 132 may use triangulation or trilateration of the measured data for localized mapping of structures in the sample 112.

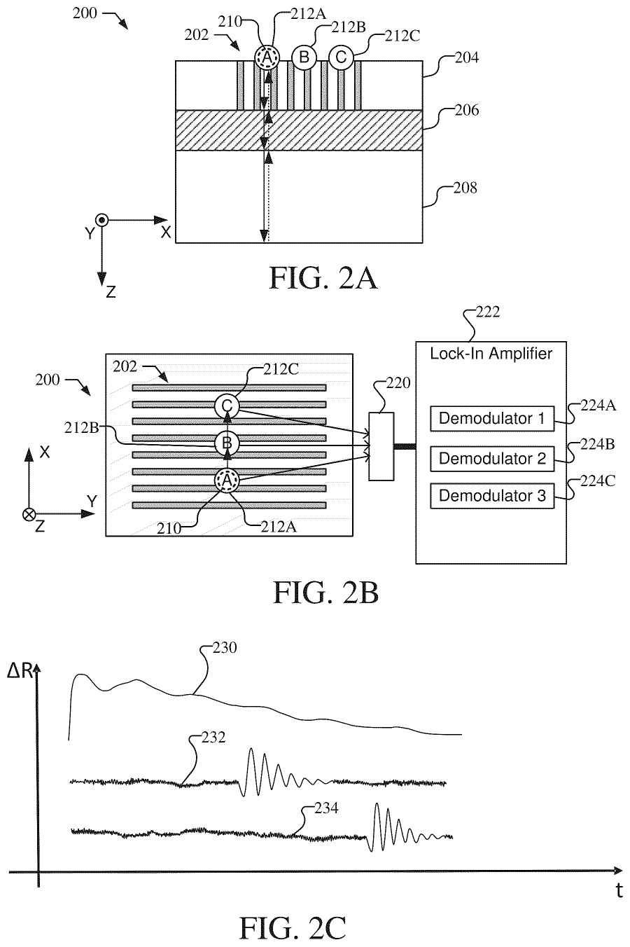

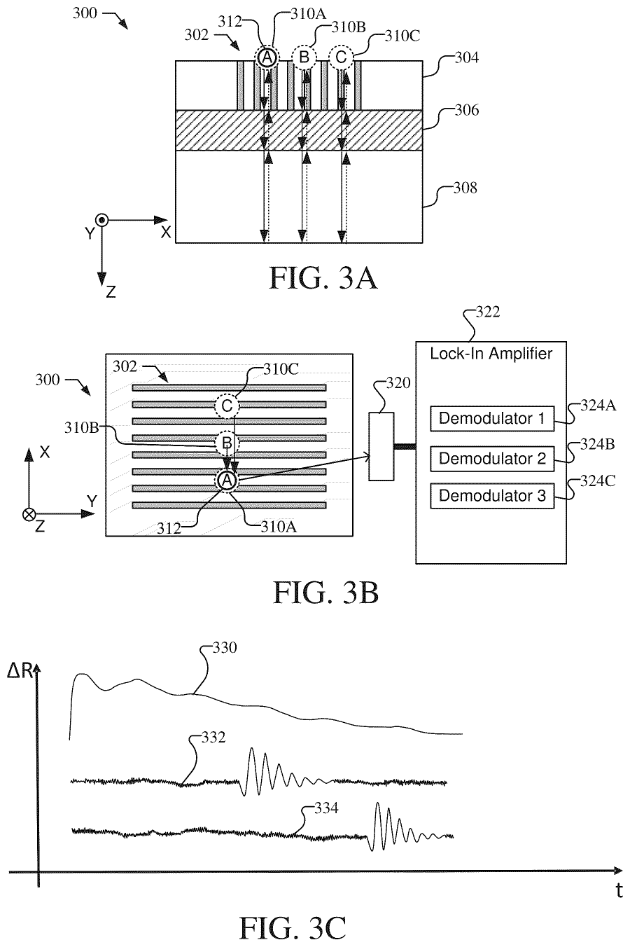

FIGS. 2A and 2B illustrate a side cross-sectional view and a top view, respectively, of a sample 200 being measured or inspected by an opto-acoustic metrology device using a single pump beam and multiple probe beams and uses orthogonal waveform modulation, such as with opto-acoustic metrology device 100 discussed in relation to FIG. 1. Sample 200 is illustrated as including a structure 202 including an array of lines in layer 204 that overlies a number of underlying layers 206 and 208. FIGS. 2A and 2B further illustrate the location of incidence of a pump beam 210 with dotted lines at location A, and illustrates the locations of incidence of multiple probe beams 212A, 212B, and 212C (sometimes referred to collectively as probe beams 212) with solid lines at different locations A, B, and C. FIGS. 2A and 2B illustrate the use of three probe beams, as opposed to two probe beams as illustrated in FIG. 1, and it should be understood that additional probe beams may be used if desired. Moreover, if desired, additional pump beams, e.g., as discussed in FIGS. 3A and 3B, may be used, i.e., multiple pump beams and multiple probe beams may be used. The displacement, e.g., both magnitude and distance, between the locations of incidence of the pump beam and probe beams may be known and used in the analysis of the resulting signals. Moreover, FIGS. 2A and 2B illustrate that the locations of incidence of the probe beams are equally distributed along a line (e.g., are linear and equally distributed along the X axis), but it should be understood that other geometrical arrangements, e.g., non-linear and/or unequally distributed, of the location of incidence may be used and may be desirable depending on the structure under test, and may be used advantageously for, e.g., triangulation or trilateration calculations.

As illustrated in FIG. 2A, the pump beam 210 is incident at location A. The pulses of light in the pump beam 210 are incident upon and at least partially absorbed by the elements of the structure 202, which causes a transient expansion in the materials of the structure 202. The transient expansion may induce ultrasonic bulk and transversal (shear) waves in the sample 200 at the same time, separately illustrated in FIGS. 2A and 2B, respectively. For example, FIG. 2A illustrates bulk waves that propagate vertically (along Z direction) through the bulk materials of the sample 200, as illustrated by solid arrows, and is reflected at each underlying interface in the film stack of layers 204, 206, and 208 which are returned, as illustrated by dotted arrows, to the surface of the structure 202. The probe beam 212A that is also incident at location A is affected by the change in reflectivity or surface deformation of the structure 202 due to the returning bulk waves. The probe beams 212B and 212C are incident at different locations than the pump beam 210 and may not be affected by the returning vertically propagating waves. The reflections of the acoustic waves due to the underlying interfaces at various depths in the sample 200 may be resolved by varying the delay between the pulses in the pump beam 210 and probe beam 212A.

If the pump beam 210 reaches and gets absorbed by the homogeneous layers under the structure 202, very little energy may go into transverse waves. However, non-uniformity at the top of the sample 200 may make more complex, coupled modes combining both bulk (vertical) and transverse components. For example, as illustrated by solid arrows in FIG. 2B, the transient expansion of the materials of the structure 202 due to the pulses of light in the pump beam 210 may induces ultrasonic transversal (surface) waves that propagate horizontally (along the X and Y directions) along the surface of the sample 200. The probe beams 212B and 212C, which are incident at different locations than the pump beam 210 are affected by the change in reflectivity or surface deformation of the structure 202 due to the surface waves, which propagate through various structural elements and materials of the structure 202. The probe beam 212A is incident at the same location as the pump beam 210. The probe beam 212A may be affected by the surface waves produced by the pump beam 210, but in some implementations, the probe beam 212A may not be affected by the surface waves produced by the pump beam 210. The surface waves produced by the pump beam 210 and that propagate through various materials and structures may be resolved at the various distances between the incidence location of the pump beam at location A and the incidence location of the probe beams 212B and 212C at locations B and C, respectively, may be resolved by varying the delay between the pulses in the pump beam 210 and probe beams 212B and 212C.

As illustrated in FIG. 2B, the probe beams 212A, 212B, and 212C reflected from locations A, B, and C, respectively, are received by a detector 220, which is coupled to a lock-in amplifier 222. The lock-in amplifier 222 includes a separate demodulator 224A, 224B, and 224C for demodulating the orthogonal waveform modulation of the reflected probe beams 212A, 212B, and 212C to phase lock on the contribution from each probe beam in the received signal.

FIG. 2C is a graph illustrating the change in reflectivity (ΔR) of the demodulated signal produced by probe beams 212A, 212B, and 212C with respect to pump-probe delay time (t). The curve 230, for example, represents the change of reflectivity in probe beam 212A due to the bulk waves, illustrated in FIG. 2A. The curves 232 and 234 represent the change of reflectivity in probe beams 212B and 212C, respectively, due to the surface waves illustrated in FIG. 2B.

FIGS. 3A and 3B illustrate a side cross-sectional view and a top view, respectively, of a sample 300 being measured or inspected by an opto-acoustic metrology device, such as with opto-acoustic metrology device 100 discussed in relation to FIG. 1. The illustration of the operation of the opto-acoustic metrology device in FIGS. 3A and 3B is similar to that shown in FIGS. 2A and 2B, but instead of using a single pump beam and multiple probe beams, as illustrated in FIGS. 2A and 2B, FIGS. 3A and 3B illustrates the use of multiple pump beams and a single probe beam. FIGS. 3A and 3B illustrate the use of three pump beams, as opposed to two pump beams as illustrated in FIG. 1, and it should be understood that additional pump beams may be used if desired. Moreover, if desired, additional probe beams, e.g., as discussed in FIGS. 2A and 2B, may be used, i.e., multiple pump beams and multiple probe beams may be used. The displacement, e.g., both magnitude and distance, between the locations of incidence of the pump beams and the probe beam may be known and used in the analysis of the resulting signals. Moreover, FIGS. 3A and 3B illustrate that the locations of incidence of the pump beams are equally distributed along a line (e.g., are linear and equally distributed along the X axis), but it should be understood that other geometrical arrangements, e.g., non-linear and/or unequally distributed, of the location of incidence may be used and may be desirable depending on the structure under test, and may be used advantageously for, e.g., triangulation or trilateration calculations.

The sample 300 illustrated in FIGS. 3A and 3B, similar to the sample 200 shown in FIGS. 2A and 2B, includes a structure 302 including an array of lines in layer 304 that overlies a number of underlying layers 306 and 308. FIGS. 3A and 3B further illustrate the location of incidence of multiple pump beams 310A, 310B, and 310C with dotted lines at different locations A, B, and C, respectively, (sometimes referred to collectively as pump beams 310) and illustrate the location of a single probe beam 312 with solid lines at location A. FIGS. 3A and 3B illustrate the use of three pump beams, as opposed to two pump beams as illustrated in FIG. 1, and it should be understood that additional pump beams may be used if desired. Moreover, FIGS. 3A and 3B illustrate that the locations of incidence of the pump beams are equally distributed along a line (e.g., along the X axis), but it should be understood that other geometrical arrangements, e.g., non-linear and/or unequally distributed, of the location of incidence may be used and may be desirable depending on the structure under test.

As illustrated in FIG. 3A, the pump beam 310A is incident at location A. The pulses of light in the pump beam 310A are incident upon and at least partially absorbed by the elements of the structure 302, which causes a transient expansion in the materials of the structure 302. The transient expansion may induce ultrasonic bulk and transversal (shear) waves in the sample 300 at the same time, separately illustrated in FIGS. 3A and 3B, respectively. For example, FIG. 3A illustrates bulk waves that propagate vertically (along Z direction) through the bulk materials of the sample 300, as illustrated by solid arrows, and is reflected at each underlying interface in the film stack of layers 304, 306, and 308 which are returned, as illustrated by dotted arrows, to the surface of the structure 302. The probe beam 312 that is also incident at location A is affected by the change in reflectivity or surface deformation of the structure 302 due to the returning bulk waves. The pump beams 310B and 310C also produce ultrasonic bulk waves that propagate vertically (along Z direction) through the bulk materials of the sample 300 and are reflected by underlying interfaces, but the pump beams 310B and 310C are incident at different locations than the probe beam 312 and, accordingly, the probe beam 312 may not be affected by the returning bulk waves produced by pump beams 310B and 310C. The reflections of the bulk wave at location A due to the underlying interfaces at various depths in the sample 300 may be resolved by varying the delay between the pulses in the pump beam 310A and probe beam 312.

If the pump beams 310A, 310B, and 310C reach and get absorbed by the homogeneous layers under the structure 302, very little energy may go into transverse waves. However, non-uniformity at the top of the sample 300 may make more complex, coupled modes combining both bulk (vertical) and transverse components. For example, as illustrated by solid arrows in FIG. 3B, the transient expansion of the materials of the structure 302 due to the pulses of light in the pump beams 310B and 310C induces ultrasonic surface waves that propagate horizontally (along the X and Y directions) along the surface of the sample 300, as illustrated by solid arrows in FIG. 3B. The probe beam 312, which is incident at a different location than the pump beams 310B and 310C are affected by the change in reflectivity or surface deformation of the structure 302 due to the surface waves induced by pump beams 310B and 310C, which propagate through various structural elements and materials of the structure 302. The pump beam 310A also produces ultrasonic surface waves (not shown), but the pump beam 310A is incident at the same location as the probe beam 312. The probe beam 312 may be affected by the surface waves produced by pump beam 310A, but in some implementations, the probe beam 312 may not be affected by the surface waves produced by pump beam 310A. The surface waves produced by the pump beams 310A and 310B and that propagate through various materials and structures may be resolved at the various distances between the incidence location of the pump beams 310B and 310C at locations B and C, respectively, and the incidence location of the probe beam 312 at location A may be resolved by varying the delay between the pulses in the pump beams 310A, 310B and the probe beam 312.

As illustrated in FIG. 3B, the probe beam 312 reflected from location A is received by a detector 320, which is coupled to a lock-in amplifier 322. Each pump beam 310A, 310B, and 310C is modulated, e.g., pump intensity modulation, with a different orthogonal waveform over time. The acoustic wave resulting from each of the pump beams 310A, 310B, and 310C will likewise vary in strength (amplitude) over time according to the respective orthogonal waveform. The probe beam 312 sensing the acoustic waves will also have a component that is modulated according to the orthogonal waveforms and the resulting signal will contain a superposition of corresponding modulation functions. The lock-in amplifier 322 includes a separate demodulator 324A, 324B, and 324C for demodulating the probe beam 312 based on the orthogonal waveform modulation of the pump beams 310A, 310B, and 310C to phase lock on the contribution from each pump beam in the received signal.

FIG. 3C, is similar to FIG. 2C, and shows a graph illustrating the change in reflectivity (ΔR) of the demodulated signal produced by probe beam 312 with respect to pump-probe delay time (t). The curve 330, for example, represents the change of reflectivity in probe beam 312 due to the bulk waves produced by pump beam 310A, illustrated in FIG. 3A. The curves 332 and 334 represent the change of reflectivity in probe beam 312 due to the surface waves produced by pump beams 310B and 310C, respectively, illustrated in FIG. 3B.

If desired, the operation of the opto-acoustic metrology device with a single pump beam and multiple probe beams as illustrated in FIGS. 2A and 2B may be combined with the operation of the opto-acoustic metrology device with multiple pump beams and a single probe beam as illustrated in FIGS. 3A and 3B for operation with multiple pump beams and multiple probe beams.

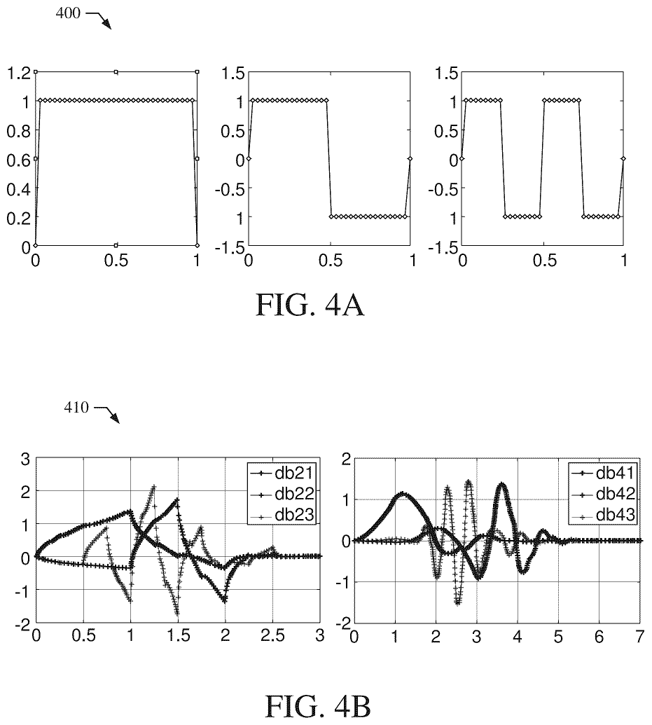

FIGS. 4A and 4B illustrate examples of orthogonal waveforms that may be used to modulate multiple probe beams and/or multiple pump beams, as discussed herein. FIG. 4A illustrates an example Haar wavelets 400 that may be used to modulate (and demodulate) three beams. FIG. 4B illustrates an example of Daubechies wavelets 410 that may be used to modulate (and demodulate) three beams.

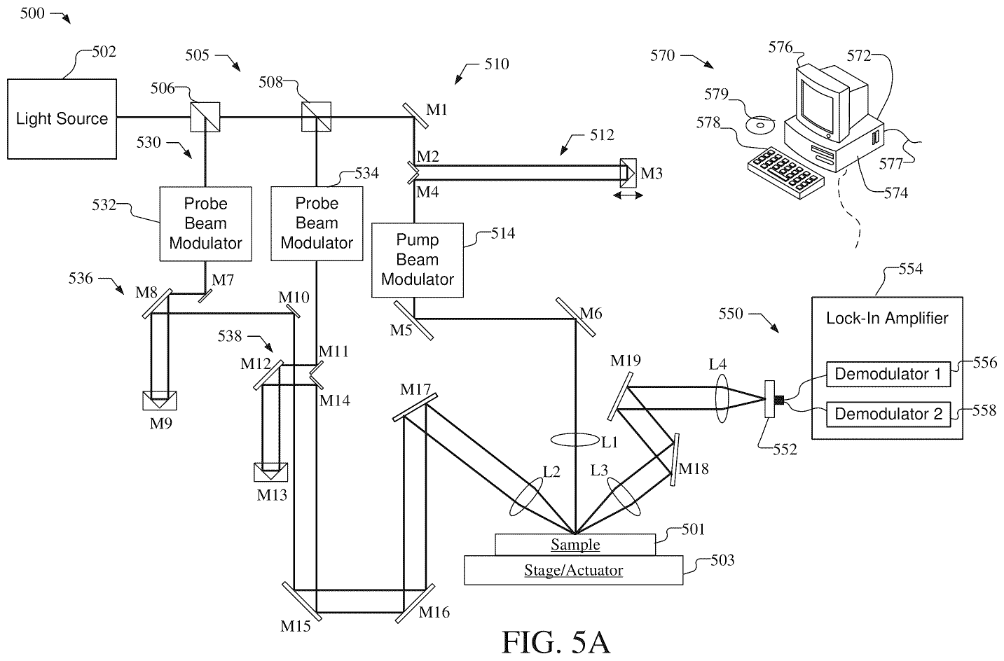

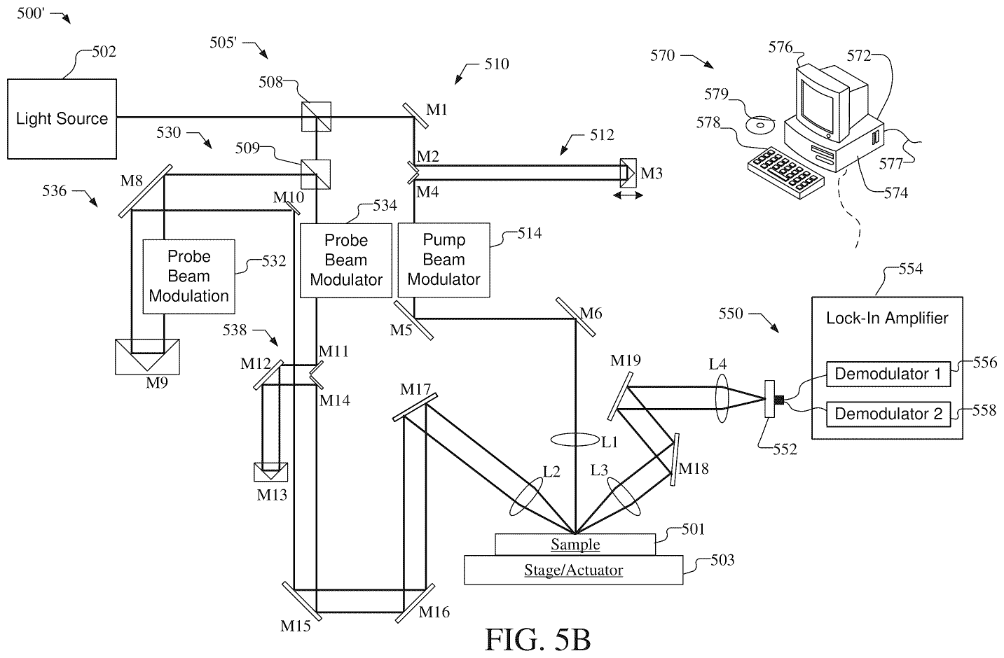

FIG. 5A illustrates a schematic representation of an example opto-acoustic metrology device 500 that uses a single pump beam and multiple probe beams that are modulated with orthogonal waveforms, as discussed herein. As illustrated, light may be produced from a light source 502, such as a 520 nm, 200 fs, 60 MHz laser, as an example, but if desired different wavelengths, pulse duration and repetition rates may be used. The light may be directed through various optical components for conditioning (not shown), such as an intensity control, which may include a half wave plate and a polarizer, and a beam expander. As illustrated, the beam may be directed to a pump probe separator 505 that separates the beam to a pump arm 510 and a probe arm 530. As illustrated, the pump probe separator may include at least one beam splitter, e.g., non-polarizing beam splitters 506 and 508, that provides the beam to the pump arm 510 that produces a single pump beam and to the probe arm 530 that produces multiple probe beams.

In the pump arm 510, the pump beam is illustrated as being directed by mirror M1 to a variable delay 512 that includes mirrors M2, M3, and M4, where mirror M3 is movable to adjust the delay in the pump beam. The mirror M3, for example, may be a retroreflector or mirror coupled to an actuator or voice coil VC with a physical displacement of, e.g., approximately 55 mm or 83.3 ps for achieving a short repeatable pump pulse time delay. The pump beam passes through a pump beam modulator 514 to modulate the intensity of the pump beam. The pump beam modulator 514, for example, may be, but is not limited to, an electro-optic modulator (EOM), followed by a polarizer and a half wave plate that may be motorized to rotate. Other intensity modulators may be used if desired. The pump beam is directed by beam steering mirrors, e.g., mirrors M5 and M6 to a focusing unit that includes a lens L1. At least one of the mirrors M5 and M6 may be attached to a piezoelectric motor to adjust the direction of the pump beam. As illustrated in FIG. 5A, the pump beam is directed through lens L1 to be normally incident on the sample 501. In some implementations, the pump beam may be directed to be obliquely incident on the sample 501, e.g., along the same beam path as the probe beams.

The probe arm 530 is illustrated as including two probe beams. For example, as illustrated, the first beam splitter 506 produces a first probe beam and the second beam splitter 508 produces a second probe beam. It should be understood that additional probe beams may be produced in a similar manner as the first and second probe beams if desired. The first probe beam passes through a first probe beam modulator 532 to modulate the intensity at a first frequency, while the second probe beam passes through a second probe beam modulator 534 to modulate the frequency at a different frequency. The probe beam modulators 532 and 534, for example, may be, but are not limited to EOMs, e.g., each followed by a polarizer and a half wave plate. The probe beam modulators 532 and 534 modulate the first probe beam and second probe beam with orthogonal waveforms, such as sine-cosine pairs, or Haar wavelets, or Daubechies wavelets, as discussed herein. The first probe beam is illustrated as being directed by mirror M7 to a first probe variable delay 536, which may include mirrors M8 and M9, and directed by mirror M10 to beam steering mirrors, e.g., mirrors M15, M16 and M17, which direct the first probe beam to a focusing unit that includes a lens L2. The mirror M9, for example, may be a retroreflector and may be a coupled to an actuator or voice coil to adjust the delay of the first probe beam. The second probe beam is illustrated as being directed by mirror M11 to a second probe variable delay 538, which may include mirrors M12 and M13, and directed by mirror M14 to the beam steering mirrors, e.g., mirrors M15, M16 and M17, which direct the second probe beam to the focusing unit that includes the lens L2. The mirror M13, for example, may be a retroreflector and may be a coupled to an actuator or voice coil to adjust the delay of the second probe beam. At least one of the steering mirrors M15, M16, and M17 may be attached to a piezoelectric motor to adjust the direction of the probe beams. As illustrated in FIG. 5A, the first and second probe beams are directed through lens L2 to be obliquely incident on the sample 501.

The incidence location of the pump beam is controlled by beam steering mirrors M5 and M6 and lens L1 and the incidence locations of the probe beams are controlled by beam steering mirrors M15, M16, and M17 and lens 2. Additionally, the different incidence locations of the first probe beam and second probe beam may be controlled, e.g., by mirrors M10 and M14.

The variable delay 512 of the pump beam and variable delays 536 and 538 of the first and second probe beams may be operated in an absolute or relative (with fixed amplitude and a sinusoidal waveform) displacement mode and may be controlled based on the propagation time of the bulk wave produced by the pump beam as well as the propagation time of the surface waves from the incidence location of the pump beam to the incidence location of the probe beam.

The reflected probe beams are received by a collection optics that includes, e.g., lens L3 and mirrors M18 and M19. The reflected beam is directed to a detection unit 550 that may include a lens L4 and a detector 552 that is coupled to a lock-in amplifier 554. The lock-in amplifier 554 includes multiple demodulators 556 and 558 to phase lock on the received signal. The demodulators 556 and 558, for example, decode the contributions from each of the first probe beam and the second pump beam to the received signal at the detector 552 based on the orthogonal waveforms of the first probe beam and second probe beam produced by the first probe beam modulator 532 and second probe beam modulator 534, respectively.

The pulses in the pump beam and probe beams may be produced with different time delays and the detector 552 may generate a plurality of signals with different time delays. Each signal generated by the detector 552 corresponds to an arrival of bulk waves from underlying layers within the patterned structure and an arrival of surface waves propagating through structures in the surface of the structure.

Additionally, as illustrated, the sample 501 is held on a stage 503 that includes or is coupled to at least one actuator configured to move the sample 501 relative to the optical system of the opto-acoustic metrology device 500 so that various locations on the sample 501 may be measured or inspected. In the depicted implementation, the device may include additional components and subsystems, such as beam management and conditioning components, such as beam expanders, collimators, polarizers, half-wave plates, etc., as well as a beam power detector, and a height detector. Those having skill in the art will appreciate variations of the devices depicted in FIGS. 1 and 5A that would still be suitable to carry out the opto-acoustic metrology techniques described herein.

The detection unit 550, e.g., detector 552 coupled to lock-in amplifier 554, as well as other components of the opto-acoustic metrology device 500, such as the light source 502, variable delays 512, 536, 538, and stage 503 upon which the sample 501 is held may be coupled to a processing system 570, such as a workstation, a personal computer, central processing unit or other adequate computer system, or multiple systems. The demodulation of the signal received by the detector 552 may be performed by analog demodulation or digital demodulation, e.g., the lock-in amplifier 554 may be analog or digital. A digital lock-in amplifier, for example, may use Digital Signal Processing (DSP) or may be based on Field Programmable Logic Arrays (FPGA. In some implementations, for example, the function of the lock-in amplifier 554 may be performed by the processing system 570. Additionally, a software based lock-in amplifier 554 may be used where the data acquisition is performed and streamed to memory, e.g., in the processing system 570, and either analyzed in place or saved in a form of non-volatile memory for analysis using signal processing algorithms.

It should be understood that one processor, multiple separate processors or multiple linked processors may be used, all of which may interchangeably be referred to herein as processing system 570. The processing system 570 is preferably included in, or is connected to, or otherwise associated with opto-acoustic metrology device 500. The processing system 570, for example, may control the positioning of the sample 501, e.g., by controlling movement of the stage 503 on which the sample 501 is held. The stage 503, for example, may be capable of horizontal motion in either Cartesian (i.e., X and Y) coordinates, or Polar (i.e., R and θ) coordinates or some combination of the two. The stage 503 may also be capable of vertical motion along the Z coordinate. The processing system 570 may further control the operation of a chuck on the stage 503 used to hold or release the sample 501. The processing system 570 may also collect and analyze the data obtained from the detector 552. The processing system 570, for example, may receive demodulated data, via the lock-in amplifier 554, or may receive a signal from the detector 552 and the processing system 570 may demodulate the signal before analyzing the data. The processing system 570 may analyze the opto-acoustic metrology data to determine characteristics of the sample 501, including the location and composition of underlying structures in the sample 501, which may be below at least one optically opaque layer using vertical transient perturbations, and the location and composition of structures in the surface of the sample 501 using lateral transient perturbations. The varying delays between the pump and probe pulses may be used by the processing system 570 to detect structures and composition of materials at different depths or locations in the surface of the sample 501. Additionally, with the use of three or more probe beams (or pump beams) and the known arrangement of the locations of incidence of the pump and probe beams, the processing system 570 may use triangulation or trilateration of the measured data for localized mapping of structures in the sample 501.

The processing system 570, which includes at least one processor 572 with memory 574, as well as a user interface including e.g., a display 576 and input devices 578. A non-transitory computer-usable storage medium 579 having computer-readable program code embodied may be used by the processing system 570 for causing the processing system 570 to control the opto-acoustic metrology device 500 and to perform the functions including the analysis described herein. The data structures, software code, etc., for automatically implementing one or more acts described in this detailed description can be implemented by one of ordinary skill in the art in light of the present disclosure and stored, e.g., on a computer-usable storage medium 579, which may be any device or medium that can store code and/or data for use by a computer system such as the at least one processor 572. The computer-usable storage medium 579 may be, but is not limited to, flash drive, magnetic and optical storage devices such as disk drives, magnetic tape, compact discs, and DVDs (digital versatile discs or digital video discs). A communication port 577 may also be used to receive instructions that are used to program the processing system 570 to perform any one or more of the functions described herein and may represent any type of communication connection, such as to the internet or any other computer network. The communication port 577 may further export signals, e.g., with measurement or inspection results and/or instructions, to another system, such as external process tools, in a feed forward or feedback process in order to adjust a process parameter associated with a fabrication process step of the samples based on the measurement results. Additionally, the functions described herein may be embodied in whole or in part within the circuitry of an application specific integrated circuit (ASIC) or a programmable logic device (PLD) or FPGA, and the functions may be embodied in a computer understandable descriptor language which may be used to create an ASIC or PLD or FPGA that operates as herein described. The results from the analysis of the data may be stored, e.g., in memory 574 associated with the sample and/or provided to a user, e.g., via display 576, an alarm or other output device. Moreover, the results from the analysis may be fed back to the process equipment to adjust the appropriate patterning step to compensate for any errors detected in the measurements or inspection.

FIG. 5B illustrates a schematic representation of an opto-acoustic metrology device 500′, which is similar to opto-acoustic metrology device 500, like designated elements being the same, but that uses a different configuration for producing the multiple probe beams.

As illustrated in FIG. 5B, for example, the opto-acoustic metrology device 500′ may include a pump probe separator 505′ that separates the beam to a pump arm 510 and a probe arm 530 with beam splitter 508. The first probe beam and the second probe beam are produced with a second beam splitter 509, e.g., which is illustrated as being before the second probe beam modulator 534 for the second probe beam. The first probe beam is illustrated as being directed by beam splitter 508 to the first probe variable delay 536, which may include mirrors M8 and M9, and directed by mirror M10 to beam steering mirrors, e.g., mirrors M15, M16 and M17, which direct the first probe beam to a focusing unit that includes a lens L2. Additionally, the first probe beam modulator 532 that modulates the intensity of the first probe beam at a first frequency is illustrated as being located after the first probe variable delay 536.

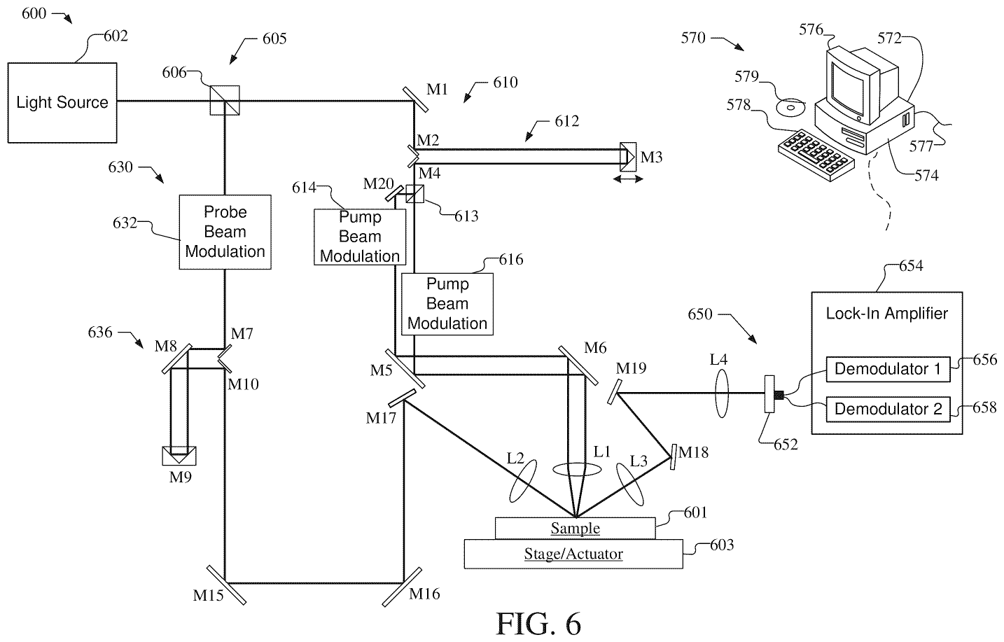

FIG. 6 illustrates a schematic representation of an example opto-acoustic metrology device 600 that uses multiple pump beams that are modulated with orthogonal waveforms and a single probe beam, as discussed herein. As illustrated, light may be produced from a light source 602, such as a 520 nm, 200 fs, 60 MHz laser. The light may be directed through various optical components for conditioning (not shown), such as an intensity control, which may include a half wave plate and a polarizer, and a beam expander. As illustrated, the beam may be directed to a pump probe separator 605 that separates the beam to a pump arm 610 and a probe arm 630. As illustrated, the pump probe separator 605 may be a beam splitter, e.g., non-polarizing beam splitter 606, that provides the beam to the pump arm 610 that produces multiple pump beams and to the probe arm 630 that produces a single probe beam.

In the pump arm 610, the pump beam is illustrated as being directed by mirror M1 to a variable delay 612 that includes mirrors M2, M3, and M4, where mirror M3 is movable to adjust the delay in the pump beam. The mirror M3, for example, may be a retroreflector or mirror coupled to an actuator with a physical displacement of, e.g., approximately 65 mm or 83.3 ps for achieving a short repeatable pump pulse time delay. The pump beam passes through a beam splitter 613 to generate a first pump beam and a second pump beam. It should be understood that additional pump beams may be produced in a similar manner as the first and second pump beams if desired. The first pump beam is directed by a mirror M20 to pass through a pump beam modulator 614 to modulate the intensity at a first frequency, while the second pump beam passes through a second pump beam modulator 616 to modulate the intensity at a different frequency. The pump beam modulators 614 and 616, for example, may be, but are not limited to EOMs, e.g., each followed by a polarizer and a half wave plate. The pump beam modulators 614 and 616 modulate the first pump beam and second pump beam with orthogonal waveforms, such as sine-cosine pairs, or Haar wavelets, or Daubechies wavelets, as discussed herein. For example, each pump beam may be intensity modulated over time with an orthogonal waveform. The first and second pump beams are directed by beam steering mirrors, e.g., mirrors M5 and M6 to the focusing unit that includes the lens L1. At least one of the mirrors M5 and M6 may be attached to a piezoelectric motor to adjust the direction of the first and second pump beams. As illustrated in FIG. 6, the first and second pump beams are directed through lens L1 to be normally incident or near normally incident on the sample 601. In some implementations, the first and second pump beams may be directed to be obliquely incident on the sample 601, e.g., along the same beam path as the probe beam.

The probe arm 630 is illustrated as including a single probe beam that passes through a probe beam modulator 632 to modulate the frequency of the probe beam. The probe beam modulator 632, for example, may be, but are not limited to EOMs, e.g., followed by a polarizer and a half wave plate. The probe beam is illustrated as being directed by mirror M7 to probe variable delay 636, which may include mirrors M8 and M9, and directed by mirror M10 to beam steering mirrors, e.g., mirrors M15, M16 and M17, which direct the probe beam to a focusing unit that includes the lens L2. The mirror M9, for example, may be a retroreflector and may be a coupled to an actuator or voice coil to adjust the delay of the probe beam. At least one of the steering mirrors M15, M16, and M17 may be attached to a piezoelectric motor to adjust the direction of the probe beam. As illustrated in FIG. 6, the probe beam is directed through lens L2 to be obliquely incident on the sample 601.

The incidence locations of the pump beams are controlled by beam steering mirrors M5 and M6 and lens L1 and the incidence location of the probe beam is controlled by beam steering mirrors M15, M16, and M17 and lens 2. Additionally, the different incidence locations of the first pump beam and second pump beam may be controlled, e.g., by mirror M20.

The variable delay 612 of the pump beams and variable delay 636 of the probe beam may be operated in an absolute or relative (with fixed amplitude and a sinusoidal waveform) displacement mode and may be controlled based on the propagation time of the bulk wave produced by the pump beam as well as the propagation time of the surface waves from the incidence location of the pump beam to the incidence location of the probe beam. The time zero calibration may be optimized depending on the pump-probe pair.

The reflected probe beam is received by a collection optics that includes, e.g., lens L3 and mirrors M18 and M19. The reflected beam is directed to a detection unit 650 that may include a lens L4 and a detector 652 that is coupled to a lock-in amplifier 654. The lock-in amplifier 654 includes multiple demodulators 656 and 658 to phase lock on the received signal. The acoustic wave resulting from each of the intensity modulated pump beams will vary in strength (amplitude) over time according to the pump beam's orthogonal waveform. The probe beam sensing the acoustic waves will also have a component that is modulated according to the orthogonal waveforms and the resulting signal will contain a superposition of corresponding modulation functions. The demodulators 656 and 658, for example, decode the contributions from each of the first pump beam and the second pump beam to the received signal at the detector 652 based on the intensity of the received signal over time and the orthogonal waveforms of the first pump beam and second pump beam produced by the first pump beam modulator 614 and second pump beam modulator 616, respectively.

The pulses in the pump beams and probe beam may be produced with different time delays and the detector 652 may generate a plurality of signals with different time delays. Each signal generated by the detector 652 corresponds to an arrival of bulk waves from underlying layers within the patterned structure and an arrival of surface waves propagating through structures in the surface of the structure.

Additionally, as illustrated, the sample 601 is held on a stage 603 that includes or is coupled to at least one actuator configured to move the sample 601 relative to the optical system of the opto-acoustic metrology device 600 so that various locations on the sample 601 may be measured or inspected. In the depicted implementation, the device may include additional components and subsystems, such as beam management and conditioning components, such as beam expanders, collimators, polarizers, half-wave plates, etc., as well as a beam power detector, and a height detector. Those having skill in the art will appreciate variations of the devices depicted in FIGS. 1 and 6 that would still be suitable to carry out the opto-acoustic metrology techniques described herein.

The detection unit 650, e.g., detector 652 coupled to lock-in amplifier 654, as well as other components of the opto-acoustic metrology device 600, such as the light source 602, variable delays 612 and 636, and stage 603 upon which the sample 601 is held may be coupled to the processing system 570, as discussed in reference to FIGS. 5A and 5B.

It should be understood that the opto-acoustic metrology device 600 may have other configurations to produce the multiple pump beams. For example, similar to generation of multiple probe beams in FIG. 5A, the multiple pump beams may be produced using multiple beam splitters in the pump probe separator. Moreover, each pump beam may have a separate variable delay and the pump beam modulators may be positioned in the beam path before or after the variable delays.

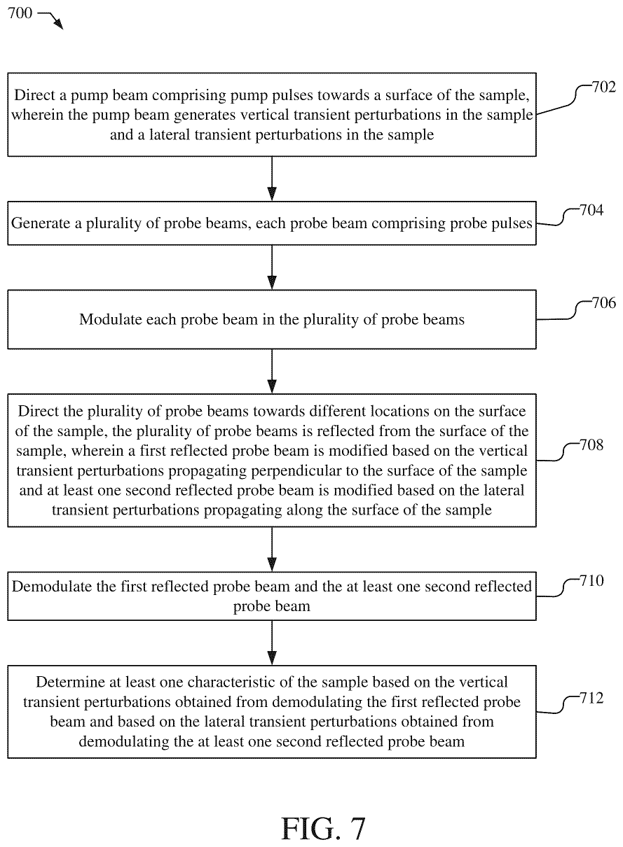

FIG. 7 is a flow chart 700 illustrating a process of opto-acoustic metrology of a sample using multiple probe beams, as discussed herein. The process, for example, may be performed using opto-acoustic metrology devices 100, 500, or 500′ shown in FIG. 1, 5A, or 5B, respectively, or the procedure illustrated in FIGS. 2A and 2B.

As illustrated, at block 702, the process includes directing a pump beam that includes pump pulses towards a surface of the sample, e.g., as discussed in reference to pump beam 121 shown in FIG. 1, and the pump beam produced in pump arm 510 shown in FIGS. 5A and 5B. The pump beam generates vertical transient perturbations in the sample and lateral transient perturbations in the sample, e.g., as discussed in reference to pump beam 210 shown in FIGS. 2A and 2B.

At block 704, the process includes generating a plurality of probe beams, each probe beam including probe pulses, e.g., as discussed in reference to probe beams 123A and 123B shown in FIG. 1, the probe beams 212A, 212B, 212C shown in FIGS. 2A and 2B, and beam splitters 506 and 508 to produce the probe beams in probe arm 530 shown in FIG. 5A, and beam splitters 508 and 509 to produce the probe beams in probe arm 530 shown in FIG. 5B.

At block 706, the process includes modulating each probe beam in the plurality of probe beams, e.g., as discussed in reference to probe beams 123A and 123B shown in FIG. 1, and the probe beams produced in probe arm 530 shown in FIGS. 5A and 5B. A means for modulating each probe beam in the plurality of probe beams in some implementations, e.g., may be probe beam modulators 125A and 125B shown in FIG. 1, and the probe beam modulators 532 and 534 shown in FIGS. 5A and 5B and may be EOMs, PEMs, AOMs, or mechanical choppers. In some implementations, the probe beams in the plurality of probe beams are modulated with orthogonal waveforms. For example, the orthogonal waveforms may be at least one of sine-cosine pairs, Haar wavelets, and Daubechies wavelets, e.g., as illustrated in FIGS. 4A and 4B.

At block 708, the process includes directing the plurality of probe beams towards different locations on the surface of the sample, the plurality of probe beams is reflected from the surface of the sample, and a first reflected probe beam is modified based on the vertical transient perturbations propagating perpendicular to the surface of the sample and at least one second reflected probe beam is modified based on the lateral transient perturbations propagating along the surface of the sample, e.g., as discussed in reference to probe beams 123A and 123B shown in FIG. 1, the probe beams 212A, 212B, 212C shown in FIGS. 2A and 2B, and the probe beams produced in probe arm 530 shown in FIGS. 5A and 5B.

At block 710, the process includes demodulating the first reflected probe beam and the at least one second reflected probe beam, e.g., as discussed in reference to the detector 128 and lock-in amplifier 129 and demodulators 130A and 130B shown in FIG. 1, the detector 220 and lock-in amplifier 222 and demodulators 224A, 224B, and 224C shown in FIG. 2B, the curves 230, 232, and 234 shown in FIG. 2C, and the detector 552 and lock-in amplifier 554 and demodulators 556 and 558 shown in FIGS. 5A and 5B. For example, a reflected signal is received by the detector 128 with contributions from the first reflected probe beam and the at least one second reflected probe beam. The contributions from each probe beam in the reflected signal received by the detector is decoded by demodulating the reflected signal based on the modulation of each probe beam. A means for demodulating the first reflected probe beam and the at least one second reflected probe beam, e.g., may be the lock-in amplifier 129 and demodulators 130A and 130B shown in FIG. 1, which may be physical band-pass filters, digital processing, or a combination thereof, the lock-in amplifier 222 and demodulators 224A, 224B, and 224C shown in FIG. 2B, and the lock-in amplifier 554 and demodulators 556 and 558 shown in FIGS. 5A and 5B.

At block 712, the process includes determining at least one characteristic of the sample based on the vertical transient perturbations obtained from demodulating the first reflected probe beam and based on the lateral transient perturbations obtained from demodulating the at least one second reflected probe beam, e.g., as discussed in reference to processing system 132 shown in FIG. 1, and the processing system 570 shown in FIGS. 5A and 5B. For example, the strength (amplitude) of the vertical transient perturbations and the lateral transient perturbations obtained from the contributions from the first reflected probe beam and the at least one second reflected probe beam in the reflected signal may be used to determine the at least one characteristic of the sample. A means for determining at least one characteristic of the sample based on the vertical transient perturbations obtained from demodulating the first reflected probe beam and based on the lateral transient perturbations obtained from demodulating the at least one second reflected probe beam, e.g., may be the processing system 132 shown in FIG. 1, and the processing system 570 shown in FIGS. 5A and 5B.

In some implementations, the process may further include varying a delay between the pump pulses and the probe pulses, e.g., as discussed in reference to pump beam source 120, probe beam sources 122A and 122B shown in FIG. 1, and the variable delays 512, 536, and 538 shown in FIGS. 5A and 5B. A means for varying a delay between the pump pulses and the probe pulses, e.g., may be the variable delays 512, 536, and 538 shown in FIGS. 5A and 5B. Determining the at least one characteristic of the sample may be further based on the delay between the pump pulses and the probe pulses, e.g., as discussed in reference to processing system 132 shown in FIG. 1, and the processing system 570 shown in FIGS. 5A and 5B.

In some implementations, the first reflected probe beam is reflected from a location on the sample that is coincident with a location of incidence of the pump beam, and the at least one second reflected probe beam is reflected from at least one location on the sample that is displaced by a known amount from the location of incidence of the pump beam, e.g., as discussed in FIGS. 2A and 2B.

In some implementations, the plurality of probe beams includes at least three probe beams and the at least three probe beams are incident on the sample at locations that are at least one of linear and equally distributed, e.g., as discussed in FIGS. 2A and 2B.

In some implementations, the plurality of probe beams includes at least three probe beams and the at least three probe beams are incident on the sample at locations that are at least one of non-linear and unequally distributed, e.g., as discussed in FIGS. 2A and 2B.

In some implementations, the method may include using a plurality of pump beams with the plurality of probe beams, e.g., as discussed in reference to FIG. 1 as well as FIGS. 2A, 2B, 3A, and 3B. For example, the pump beam may be one of a plurality of pump beams, each pump beam comprising pump pulses and the method may include modulating each pump beam in the plurality of pump beams, e.g., as discussed in reference to pump beams 121 and 121′ shown in FIG. 1, the pump beams 310A, 310B, 310C shown in FIGS. 3A and 3B, and beam splitters 606 and 613 to produce the pump beams in pump arm 610 shown in FIG. 6, and discussed, e.g., as discussed in reference to pump beams 121 and 121′ shown in FIG. 1, and the pump beams produced in the pump arm 610 shown in FIG. 6. A means for modulating each pump beam in the plurality of pump beams, e.g., may be the pump beam modulator 124 shown in FIG. 1, and the pump beam modulators 614 and 616 shown in FIG. 6, and may be an EOM. In some implementations, the pump beams in the plurality of pump beams are modulated with orthogonal waveforms. For example, the orthogonal waveforms may be at least one of sine-cosine pairs, Haar wavelets, and Daubechies wavelets, e.g., as illustrated in FIGS. 4A and 4B. The plurality of pump beams may be directed towards different locations on the surface of the sample, wherein each pump beam excites transient perturbations in the sample at corresponding locations e.g., as discussed in reference to pump beams 121, 121′ shown in FIG. 1, and the pump beams produced in pump arm 610 shown in FIG. 6, and in reference to pump beams 310 shown in FIGS. 3A and 3B. The first reflected probe beam and the at least one second reflected probe beam may be further modified based on the transient perturbations excited by the plurality of pump beams e.g., as discussed in reference to probe beam 123A shown in FIG. 1, the probe beam 312 shown in FIGS. 3A and 3B, and the probe beam produced in probe arm 630 shown in FIG. 6. The first reflected probe beam and the at least one second reflected probe beam may be demodulated based on modulation of each probe beam in the plurality of probe beams to determine contributions from each probe beam and further based on modulation of each pump beam in the plurality of pump beams to determine contributions from each pump beam. A means for demodulating the first reflected probe beam and the at least one second reflected probe, e.g., may be the lock-in amplifier 129 and demodulators 130A and 130B shown in FIG. 1, the lock-in amplifier 322 and demodulators 324A, 324B, and 324C shown in FIG. 2B, and the lock-in amplifier 654 and demodulators 656 and 658 shown in FIG. 6. Additionally, the at least one characteristic of the sample may be determined further based on the transient perturbations excited by the plurality of pump beams and obtained from demodulating the first reflected probe beam and the at least one second reflected probe beam. A means for determining at least one characteristic of the sample further based on the transient perturbations excited by the plurality of pump beams and obtained from demodulating the first reflected probe beam and the at least one second reflected probe beam, e.g., may be the processing system 132 shown in FIG. 1, and the processing system 570 shown in FIGS. 5A and 6.

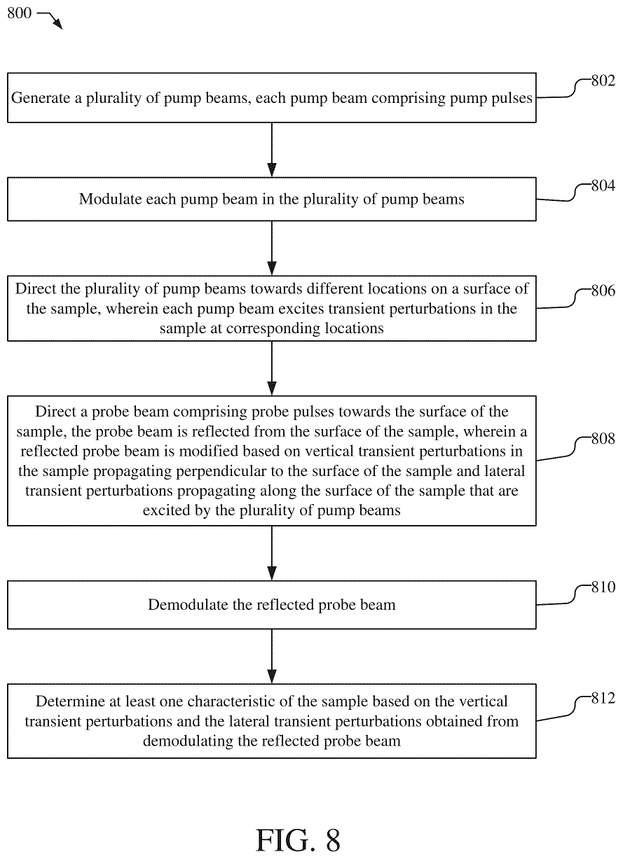

FIG. 8 is a flow chart 800 illustrating a process of opto-acoustic metrology of a sample using multiple pump beams, as discussed herein. The process, for example, may be performed using opto-acoustic metrology devices 100 or 600 shown in FIG. 1 or 6, respectively, or the procedure illustrated in FIGS. 3A and 3B.

As illustrated, at block 802, the process includes generating a plurality of pump beams, each pump beam comprising pump pulses, e.g., as discussed in reference to pump beams 121 and 121′ shown in FIG. 1, the pump beams 310A, 310B, 310C shown in FIGS. 3A and 3B, and beam splitters 606 and 613 to produce the pump beams in pump arm 610 shown in FIG. 6.

At block 804, the process includes modulating each pump beam in the plurality of pump beams, e.g., as discussed in reference to pump beams 121 and 121′ shown in FIG. 1, and the pump beams produced in the pump arm 610 shown in FIG. 6. A means for modulating each pump beam in the plurality of pump beams, e.g., may be the pump beam modulator 124 shown in FIG. 1, and the pump beam modulators 614 and 616 shown in FIG. 6, and may be an EOM. In some implementations, the pump beams in the plurality of pump beams are modulated with orthogonal waveforms. For example, the orthogonal waveforms may be at least one of sine-cosine pairs, Haar wavelets, and Daubechies wavelets, e.g., as illustrated in FIGS. 4A and 4B.

At block 806, the process includes directing the plurality of pump beams towards different locations on a surface of the sample, wherein each pump beam excites transient perturbations in the sample at corresponding locations, e.g., as discussed in reference to pump beams 121, 121′ shown in FIG. 1, and the pump beams produced in pump arm 610 shown in FIG. 6. Each pump beam excites transient perturbations in the sample at corresponding locations, e.g., as discussed in reference to pump beams 310 shown in FIGS. 3A and 3B.

At block 808, the process includes directing a probe beam including probe pulses towards the surface of the sample, the probe beam is reflected from the surface of the sample, and a reflected probe beam is modified based on vertical transient perturbations in the sample propagating perpendicular to the surface of the sample and lateral transient perturbations propagating along the surface of the sample that are excited by the plurality of pump beams, e.g., as discussed in reference to probe beam 123A shown in FIG. 1, the probe beam 312 shown in FIGS. 3A and 3B, and the probe beam produced in probe arm 630 shown in FIG. 6.

At block 810, the process includes demodulating the reflected probe beam, e.g., as discussed in reference to the detector 128 and lock-in amplifier 129 and demodulators 130A and 130B shown in FIG. 1, the detector 320 and lock-in amplifier 322 and demodulators 324A, 324B, and 324C shown in FIG. 2B, the curves 330, 332, and 334 shown in FIG. 3C, and the detector 652 and lock-in amplifier 654 and demodulators 656 and 658 shown in FIG. 6. For example, a reflected signal is received by the detector 128 with acoustic signal contributions produced by each of the pump beams. The contributions produced by each pump beam in the reflected signal received by the detector is decoded by demodulating the reflected signal based on the modulation of each pump beam. A means for demodulating the reflected probe beam, e.g., may be the lock-in amplifier 129 and demodulators 130A and 130B shown in FIG. 1, the lock-in amplifier 322 and demodulators 324A, 324B, and 324C shown in FIG. 2B, and the lock-in amplifier 654 and demodulators 656 and 658 shown in FIG. 6.

At block 812, the process includes determining at least one characteristic of the sample based on the vertical transient perturbations and the lateral transient perturbations obtained from demodulating the reflected probe beam, e.g., as discussed in reference to processing system 132 shown in FIG. 1, and the processing system 570 shown in FIGS. 5A and 6. For example, the strength (amplitude) of the vertical transient perturbations and the lateral transient perturbations obtained from the contributions produced by each pump beam in the reflected signal may be used to determine the at least one characteristic of the sample. A means for determining at least one characteristic of the sample based on the vertical transient perturbations and the lateral transient perturbations obtained from demodulating the reflected probe beam, e.g., may be the processing system 132 shown in FIG. 1, and the processing system 570 shown in FIGS. 5A and 6.

In some implementations, the process may further include varying a delay between the pump pulses and the probe pulses, e.g., as discussed in reference to pump beam source 120, probe beam source 122A shown in FIG. 1, and the variable delays 612 and 636 shown in FIG. 6. A means for varying a delay between the pump pulses and the probe pulses, e.g., may be the variable delays 612 and 636 shown in FIG. 6. Determining the at least one characteristic of the sample may be further based on the delay between the pump pulses and the probe pulses, e.g., as discussed in reference to processing system 132 shown in FIG. 1, and the processing system 570 shown in FIG. 6.

In some implementations, the probe beam is incident on the sample at a location that is coincident with a first location of incidence of one pump beam, and locations of incidence of remaining pump beams in the plurality of pump beams are displaced by a known amount from the first location, e.g., as discussed in FIGS. 3A and 3B. For example, the reflected probe beam may be modified based on the vertical transient perturbations excited at the first location and the lateral transient perturbations excited at the locations of incidence of the remaining pump beams, e.g., as discussed in FIGS. 3A and 3B.

In some implementations, the plurality of pump beams includes at least three pump beams and the at least three pump beams are incident on the sample at locations that are at least one of linear and equally distributed, e.g., as discussed in FIGS. 3A and 3B.

In some implementations, the plurality of pump beams includes at least three pump beams and the at least three pump beams are incident on the sample at locations that are at least one of non-linear and unequally distributed, e.g., as discussed in FIGS. 3A and 3B.

Those skilled in the art will understand that the preceding implementations of the present disclosure provide the foundation for numerous alternatives and modifications that are also deemed within the scope of the present disclosure. The above description is intended to be illustrative, and not restrictive. For example, the above-described examples (or one or more aspects thereof) may be used in combination with each other. For example, the present disclosure has been described throughout using a single pump beam and multiple probe beams or multiple pump beams and a single probe beam, but a combination of multiple pump beams and multiple probe beams would work as well in all of the disclosed systems. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method of opto-acoustic metrology of a sample, comprising:
directing a pump beam comprising pump pulses towards a surface of the sample, wherein the pump beam generates vertical transient perturbations in the sample and lateral transient perturbations in the sample;
generating a plurality of probe beams, each probe beam comprising probe pulses;
modulating each probe beam in the plurality of probe beams;
directing the plurality of probe beams towards different locations on the surface of the sample, the plurality of probe beams is reflected from the surface of the sample, wherein a first reflected probe beam is modified based on the vertical transient perturbations propagating perpendicular to the surface of the sample and at least one second reflected probe beam is modified based on the lateral transient perturbations propagating along the surface of the sample;
demodulating the first reflected probe beam and the at least one second reflected probe beam; and
determining at least one characteristic of the sample based on the vertical transient perturbations obtained from demodulating the first reflected probe beam and based on the lateral transient perturbations obtained from demodulating the at least one second reflected probe beam.

2. The method of claim 1, wherein probe beams in the plurality of probe beams are modulated with orthogonal waveforms.

3. The method of claim 2, wherein the orthogonal waveforms comprise at least one of sine-cosine pairs, Haar wavelets, and Daubechies wavelets.

4. The method of claim 1, further comprising:
varying a delay between the pump pulses and the probe pulses;
wherein determining the at least one characteristic of the sample is further based on the delay between the pump pulses and the probe pulses.

5. The method of claim 1, wherein the first reflected probe beam is reflected from a location on the sample that is coincident with a location of incidence of the pump beam, and the at least one second reflected probe beam is reflected from at least one location on the sample that is displaced by a known amount from the location of incidence of the pump beam.

6. The method of claim 1, wherein the plurality of probe beams comprises at least three probe beams and the at least three probe beams are incident on the sample at locations that are at least one of linear and equally distributed.

7. The method of claim 1, wherein the plurality of probe beams comprises at least three probe beams and the at least three probe beams are incident on the sample at locations that are at least one of non-linear and unequally distributed.

8. The method of claim 1, wherein the pump beam is one of a plurality of pump beams, each pump beam comprising pump pulses, the method further comprising:
modulating each pump beam in the plurality of pump beams;
directing the plurality of pump beams towards different locations on the surface of the sample, wherein each pump beam excites transient perturbations in the sample at corresponding locations;
wherein the first reflected probe beam and the at least one second reflected probe beam are modified based on the transient perturbations excited by the plurality of pump beams;
wherein demodulating the first reflected probe beam and the at least one second reflected probe beam is based on modulation of each probe beam in the plurality of probe beams to determine contributions from each probe beam and further based on modulation of each pump beam in the plurality of pump beams to determine contributions from each pump beam;
wherein determining the at least one characteristic of the sample is further based on the transient perturbations excited by the plurality of pump beams and obtained from demodulating the first reflected probe beam and the at least one second reflected probe beam.

9. A metrology device for opto-acoustic metrology of a sample, comprising:
a pump arm that is configured to receive at least a first portion of pulsed light from a light source and to direct a pump beam comprising pump pulses towards a surface of the sample, wherein the pump beam generates vertical transient perturbations in the sample and lateral transient perturbations in the sample;
a probe arm that is configured to receive at least a second portion of the pulsed light from the light source and to direct a plurality of probe beams towards different locations on the surface of the sample, each probe beam comprising probe pulses, the probe arm comprising a means for modulating each probe beam in the plurality of probe beams, the plurality of probe beams is reflected from the surface of the sample, wherein a first reflected probe beam is modified based on the vertical transient perturbations propagating perpendicular to the surface of the sample and at least one second reflected probe beam is modified based on the lateral transient perturbations in the sample propagating along the surface of the sample;
means for demodulating the first reflected probe beam and the at least one second reflected probe beam; and
means for determining at least one characteristic of the sample based on the vertical transient perturbations obtained from demodulating the first reflected probe beam and based on the lateral transient perturbations obtained from demodulating the at least one second reflected probe beam.

10. The metrology device of claim 9, wherein probe beams in the plurality of probe beams are modulated with orthogonal waveforms.

11. The metrology device of claim 10, wherein the orthogonal waveforms comprise at least one of sine-cosine pairs, Haar wavelets, and Daubechies wavelets.

12. The metrology device of claim 9, further comprising:
means for varying a delay between the pump pulses and the probe pulses;
wherein the means for determining the at least one characteristic of the sample is further based on the delay between the pump pulses and the probe pulses.

13. The metrology device of claim 9, wherein the metrology device comprises focusing optics configured to cause the first reflected probe beam to be reflected from a location on the sample that is coincident with a location of incidence of the pump beam, and to cause the at least one second reflected probe beam to be reflected from at least one location on the sample that is displaced by a known amount from the location of incidence of the pump beam.

14. The metrology device of claim 9, wherein the plurality of probe beams comprises at least three probe beams and the metrology device comprises focusing optics configured to cause the at least three probe beams to be incident on the sample at locations that are at least one of linear and equally distributed.

15. The metrology device of claim 9, wherein the plurality of probe beams comprises at least three probe beams and the metrology device comprises focusing optics configured to cause the at least three probe beams to be incident on the sample at locations that are at least one of non-linear and unequally distributed.

16. The metrology device of claim 9, wherein:
wherein the pump beam is one of a plurality of pump beams, and the pump arm is further configured to direct the plurality of pump beams towards different locations on the surface of the sample, each pump beam comprising pump pulses, the pump arm comprising a means for modulating each pump beam in the plurality of pump beams, wherein each pump beam excites transient perturbations in the sample at corresponding locations;
wherein the first reflected probe beam and the at least one second reflected probe beam are modified based on the transient perturbations excited by the plurality of pump beams;
wherein the means for demodulating the first reflected probe beam and the at least one second reflected probe beam demodulates based on modulation of each probe beam in the plurality of probe beams to determine contributions from each probe beam and further based on modulation of each pump beam in the plurality of pump beams to determine contributions from each pump beam;
wherein the means for determining at least one characteristic of the sample determines the at least one characteristic further based on the transient perturbations excited by the plurality of pump beams and obtained from demodulating the first reflected probe beam and the at least one second reflected probe beam.

17. A method of opto-acoustic metrology of a sample, comprising:
generating a plurality of pump beams, each pump beam comprising pump pulses;
modulating each pump beam in the plurality of pump beams;
directing the plurality of pump beams towards different locations on a surface of the sample, wherein each pump beam excites transient perturbations in the sample at corresponding locations;
directing a probe beam comprising probe pulses towards the surface of the sample, the probe beam is reflected from the surface of the sample, wherein a reflected probe beam is modified based on vertical transient perturbations in the sample propagating perpendicular to the surface of the sample and lateral transient perturbations propagating along the surface of the sample that are excited by the plurality of pump beams;
demodulating the reflected probe beam; and
determining at least one characteristic of the sample based on the vertical transient perturbations and the lateral transient perturbations obtained from demodulating the reflected probe beam.

18. The method of claim 17, wherein pump beams in the plurality of pump beams are modulated with orthogonal waveforms.

19. The method of claim 18, wherein the orthogonal waveforms comprise at least one of sine-cosine pairs, Haar wavelets, and Daubechies wavelets.

20. The method of claim 17, further comprising:
varying a delay between the pump pulses and the probe pulses;
wherein determining the at least one characteristic of the sample is further based on the delay between the pump pulses and the probe pulses.

21. The method of claim 17, wherein the probe beam is incident on the sample at a location that is coincident with a first location of incidence of one pump beam, and locations of incidence of remaining pump beams in the plurality of pump beams are displaced by a known amount from the first location.

22. The method of claim 21, wherein the reflected probe beam is modified based on the vertical transient perturbations excited at the first location and the lateral transient perturbations excited at the locations of incidence of the remaining pump beams.

23. The method of claim 17, wherein the plurality of pump beams comprises at least three pump beams and the at least three pump beams are incident on the sample at locations that are at least one of linear and equally distributed.

24. The method of claim 17, wherein the plurality of pump beams comprises at least three pump beams and the at least three pump beams are incident on the sample at locations that are at least one of non-linear and unequally distributed.

25. A metrology device for opto-acoustic metrology of a sample, comprising:
a pump arm that is configured to receive at least a first portion of pulsed light from a light source and to direct a plurality of pump beams towards different locations on a surface of the sample, each pump beam comprising pump pulses, the pump arm comprising a means for modulating each pump beam in the plurality of pump beams, wherein each pump beam excites transient perturbations in the sample at corresponding locations;
a probe arm that is configured to receive at least a second portion of the pulsed light from the light source and to direct a probe beam comprising probe pulses towards the surface of the sample, the probe beam is reflected from the surface of the sample, wherein a reflected probe beam is modified based on vertical transient perturbations in the sample propagating perpendicular to the surface of the sample and lateral transient perturbations propagating along the surface of the sample that are excited by the plurality of pump beams;
means for demodulating the reflected probe beam; and
means for determining at least one characteristic of the sample based on the vertical transient perturbations and the lateral transient perturbations obtained from demodulating the reflected probe beam.

26. The metrology device of claim 25, wherein pump beams in the plurality of pump beams are modulated with orthogonal waveforms.

27. The metrology device of claim 26, wherein the orthogonal waveforms comprise at least one of sine-cosine pairs, Haar wavelets, and Daubechies wavelets.

28. The metrology device of claim 25, further comprising:
means for varying a delay between the pump pulses and the probe pulses;
wherein the means for determining the at least one characteristic of the sample is further based on the delay between the pump pulses and the probe pulses.

29. The metrology device of claim 25, wherein the metrology device comprises focusing optics configured to cause the probe beam to be incident on the sample at a first location that is coincident with a location of incidence of one pump beam and to cause remaining pump beams in the plurality of pump beams to be incident at locations that are displaced by a known amount from the first location.

30. The metrology device of claim 29, wherein the reflected probe beam is modified based on the vertical transient perturbations excited at the first location and the lateral transient perturbations excited at the locations of incidence of the remaining pump beams.

31. The metrology device of claim 25, wherein the plurality of pump beams comprises at least three pump beams and the metrology device comprises focusing optics configured to cause the at least three pump beams to be incident on the sample at locations that are at least one of linear and equally distributed.

32. The metrology device of claim 25, wherein the plurality of pump beams comprises at least three pump beams and the metrology device comprises focusing optics configured to cause the at least three pump beams to be incident on the sample at locations that are at least one of non-linear and unequally distributed.
